(19) United States
(12) Patent Application Publication
(10) Pub. No.: US 2004/0135301 A1
(43) Pub. Date: Jul. 15, 2004

(54) Bearing for a piston rod

(75) Inventors: Gunther Handke, Euerbach (DE); Michael Hurrlein, Hammelburg (DE); Gabriela Hurrlein, Hammelburg (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/695,963

(22) Filed: Oct. 29, 2003

(30) Foreign Application Priority Data
Oct. 30, 2002 (DE) 102 50 436.9

(51) Int. Cl. F16F 1/44; B60G 11/22

(52) U.S. Cl. 267/293

(57) ABSTRACT

Bearing for a piston rod of a piston-cylinder unit, including a bearing body mounting on the piston rod side and a counter-bearing of a component to be carried by the piston rod. The counter-bearing is designed as a bearing flange, the top and bottom side of which are fitted with respective bearing bodies in the form of slide bearings. The bearing body mounting supports the counter-bearing axially on both sides and the two bearing bodies are preloaded by a spring towards the bearing body mounting.

### BACKGROUND OF THE INVENTION

1. Field of the Invention

The invention relates to a bearing for a piston rod including a bearing body mounting for mounting to a piston rod, a counter-bearing for a component to be carried by the piston rod, and at least one bearing body arranged between the mounting and the counter-bearing.

2. Description of the Related Art

DE 27 13 133 C2 discloses a bearing for a vibration damper in the area of the piston rod, the bearing itself being designed as a deep-groove ball bearing. A circumferential groove, which in the final assembled state of the bearing accommodates the balls, is recessed in the piston rod. On the outside, the balls are carried by two separate raceway shells, a lower raceway shell being preloaded by an axially moveable spring plate connected to a vehicle suspension spring. The advantage of a bearing for the piston rod is that in the case of a suspension movement of the vibration damper, in which the cylinder of the vibration damper may sometimes perform a rotational movement in relation to the piston rod, this rotational movement is shifted into the bearing due to the frictional forces in the area of the piston ring and/or the piston rod/piston rod seal, so that despite a relative movement of the piston rod in relation to the vehicle body it does not move in relation to the cylinder. The entire vibration damper is decoupled from the vehicle body in a peripheral direction. This improves the responsiveness of the vibration damper. If the piston rod can only ever perform axial movements in relation to the cylinder, the sealing and friction points in the area of the piston ring or the piston ring seal can be better designed to suit the purpose.

DE 80 26 889 U1 describes a spring strut, the spring plate of which is capable, by way of a slide bearing, of rotating in relation to the piston rod. An independent piston rod bearing is, however, not provided. GB 2 050 557, which shows a very similar design principle, should also be cited in this context.

### SUMMARY OF THE INVENTION

The object of the present invention is to create a bearing for a piston rod, which is independent of the use of a spring plate connection with a vehicle suspension spring.

According to the invention, the counter-bearing is designed as a bearing flange, the top and bottom side of which is in each case fitted with a bearing body in the form of a slide bearing, the bearing body mounting on the piston rod side supporting the counter-bearing axially on both sides. The two bearing bodies are preloaded by a spring towards the bearing body mounting on the piston rod side.

The use of two bearing bodies means that tensile and compressive forces associated with a rotational movement of the piston rod are in each case introduced into the bearing with little friction. Furthermore, the spring ensures that the bearing on the whole functions free from play and therefore with little noise.

In a further advantageous development, at least one bearing body is supported by an axially moveable backing disk. This means that even a material with little inherent load bearing capacity can be used as bearing body. In selecting the material the person skilled in the art may prefer materials affording optimum resistance to friction or particularly durable materials. The support function is provided by the backing disk.

The bearing is generally fastened on a piston rod step by means of a fixing nut. In order that the bearing cannot be preloaded by the nut to the point of complete locking, the bearing body mounting on the piston rod side has a sleeve section, which defines a minimum interval between the two bearing bodies.

In principle the spring may feasibly be arranged axially outside or axially inside the stack comprising the bearing bodies and the bearing flange of the counter-bearing. It has to be decided in each individual instance which of the two variants is to be preferred. In deciding, the overall space available for the spring, for example, may be a deciding factor.

It is also possible for a bearing disk to have a threaded sleeve section, which supports the bearing disk so that it is axially adjustable. The bearing is thereby adjustable and can be preassembled as a standard unit regardless of its actual application.

In order to be able to dimension the bearing bodies irrespective of the diameter ratios on the piston rod, the bearing bodies are located between a lower bearing disk and an upper bearing disk of the bearing body mounting on the piston rod side.

In addition to the axial, bearing the bearing flange is centered in relation to the piston rod by a bearing body absorbing radial force.

With a view to minimizing the number of components and also to an advantageous of increase in component strength, the bearing body absorbing radial force is integrally formed with one of the two other bearing bodies.

In one embodiment of the bearing, the bearing flange of the counter-bearing is formed by an upper shell and a lower shell, between which an elastomer body is arranged, which preloads the two shells towards the two bearing bodies. The elastomer body may be an integral part of the complete piston rod bearing for a component to be carried.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is an axial section view of a bearing assembly according to the invention fitted to a piston rod;

FIG. 2A is a partial axial section view of a second embodiment of the bearing assembly; and

FIG. 2B is a partial axial section view of a third embodiment of the bearing assembly.

### DETAILED DESCRIPTION OF THE PRESENTLY PREFERRED EMBODIMENTS

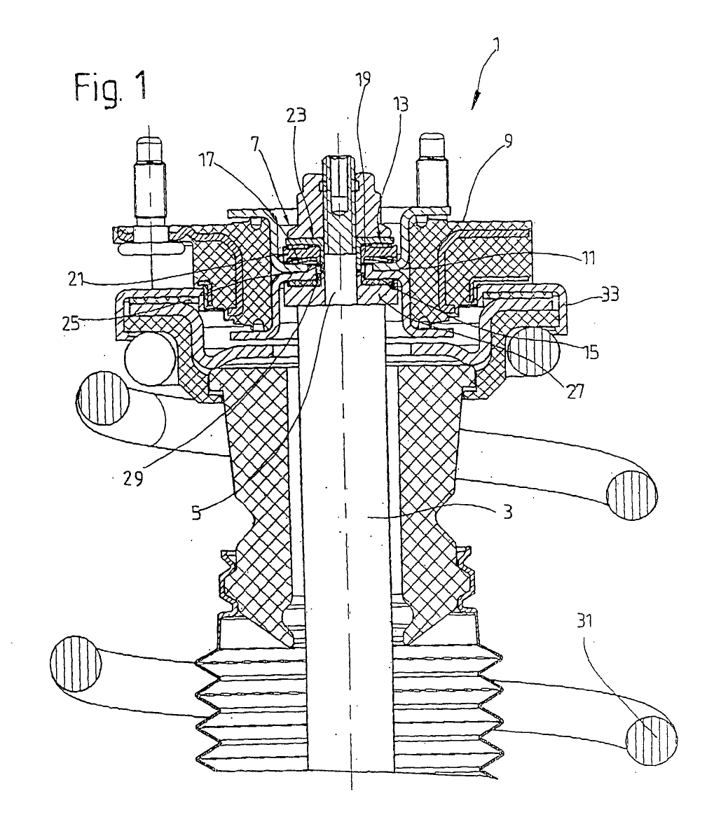

FIG. 1 shows a bearing 1 for a piston rod 3 of a piston-cylinder unit, such as a spring strut for a motor vehicle, for example, although the invention is not limited to such a technical application. A peg section 5 of the piston rod carries bearing body mounting 7 on the piston rod side, the mounting interacting with a counter-bearing 9 of a component to be carried by the piston rod. The counter-bearing has a bearing flange 11, the top and bottom side of which are pressed together in the flange area. In the pressing process smooth surfaces are produced on the bearing flange. Between the bearing body mounting 7 on the piston rod side and the counter-bearing 9, bearing bodies 13; 15 are arranged on both sides, which are preloaded towards the bearing body mounting on the piston rod side by a spring 17. The entire bearing body mounting is fixed on the conical section of the piston rod by a fixing nut 19. In this embodiment, one of the bearing bodies is supported by an axially moveable backing disk 21, the spring pressing the bearing body together with the backing disk against an upper bearing disk 23 of the bearing body mounting. The upper bearing disk 23 is integrally joined to a sleeve section 25, which defines a minimum interval between the two bearing bodies, the sleeve section resting on a lower bearing disk 27.

In this example of an embodiment the lower bearing body is integrally formed with a bearing body 29 absorbing radial force and accordingly has an angular cross-section.

In assembling, a suspension spring 31, which in the case of a vibration damper for a motor vehicle is the vehicle suspension spring, is first pushed over the piston rod. A spring plate 33 is then threaded onto the piston rod and the suspension spring is axially preloaded in the compression direction using a suitable tool, so that the lower bearing disk 27 can be placed on the peg section 5 of the piston rod. The lower bearing disk 27 supports the lower bearing body 15, on which the bearing flange 11 of the counter-bearing 9 is in turn placed. Resting on the top side of the bearing flange 11 is the spring 17, in this case a disk spring which preloads the backing disk 21 together with the upper bearing body against the underside of the upper bearing disk. The spring 17 is thereby arranged axially inside the stack comprising the bearing bodies 13, 15 of the bearing flange of the counter-bearing. The bearing body 15 mounting on the piston rod side is preloaded and the complete bearing fixed on the piston rod by the fixing nut 19. Regardless of the direction in which force is introduced, there is always a bearing body 13; 15 available, which transmits the force from the piston rod 3 to the bearing flange 11 of the counter bearing 9. The spring 17 ensures that there is no play inside the bearing body mounting.

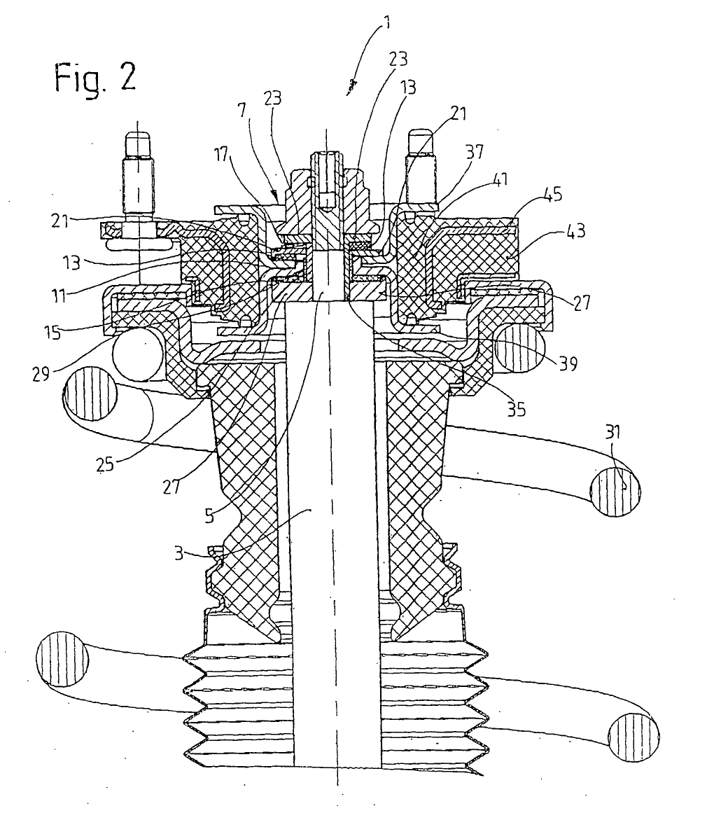

FIGS. 2A and 2B show two variants of an arrangement of bearing bodies inside a bearing body mounting. In FIG. 2A the spring 17 is, in contrast to FIG. 1, designed to lie axially outside the stack comprising the bearing bodies 13; 15 and the bearing flange 11 of the counter-bearing. The sleeve section 25 is formed by a separate sleeve and the bearing body 29 absorbing radial force also represents an independent component. As already stated previously, the bearing flange 11 is produced by a pressing process and has a surface of a quality such that the upper bearing body 13 can be placed directly on the bearing flange. The backing disk 21 provides for axial guidance and a circumferential edge of the backing disk prevents any radial migration of the bearing body 13.

In FIG. 2B a bearing disk 23, in this case the upper disk, has a threaded sleeve section 35, which engages in a thread on the lower bearing disk 27, so that the upper bearing disk is axially adjustable in relation to the lower bearing disk. In contrast to the other design variants the bearing flange 11 is formed by an upper shell 37 and a lower shell 39, between which an elastomer body 41 is arranged, which preloads the two shells towards the two bearing bodies 13; 15. The two shell parts 37, 39 can move axially in relation to one another. The backing disk 21 lies on the upper shell 37 and supports the upper bearing body 13. The elastomer body transmits the forces from the piston rod to the supporting component. Arranged concentrically with the elastomer body is a second elastomer body 43, which is isolated from the first elastomer body by a suitably designed sheathing 45 and only transmits the forces from the suspension spring 31 to the supporting component. In this embodiment the bearing may be assembled separately and independently of the other components. A torsion safeguard can be produced by suitably securing the upper bearing disk 23 to the lower bearing disk 27, for example by caulking the threaded part of the threaded sleeve section and the thread of the lower bearing disk. Consequently no adjusting movement can be transmitted to the upper bearing disk even under the movement involved in screwing the fixing nut on.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A bearing assembly for a piston rod of a piston cylinder unit, said bearing assembly comprising:
a counter-bearing of a component to be carried by the piston rod, said counter bearing comprising a bearing flange having a top side and a bottom side;
a bearing body mounting for mounting on the piston rod, said mounting supporting said flange axially on both sides;
a slide bearing between said top side and said bearing body mounting;
a slide bearing between said bottom side and said bearing body mounting;
an axially movable backing disk carrying one of said slide bearings; and
a spring which preloads said slide bearings toward the bearing body mounting.

2. A bearing assembly as in claim 1 wherein said bearing body mounting comprises a sleeve section which defines a minimum distance between said slide bearings.

3. A bearing assembly as in claim 1 wherein said spring is arranged axially outside of said slide bearings.

4. A bearing assembly as in claim 1 wherein said spring is arranged axially inside of said slide bearings.

5. A bearing assembly as in claim 1 wherein said bearing body mounting comprises an upper bearing disk and a lower bearing disk, said slide bearing being arranged axially between said bearing disks.

6. A bearing assembly as in claim 5, wherein one of said bearing disks has a threaded sleeve section which engages a thread of the other bearing disk so that the relative axial position of the two bearing disks is adjustable.

7. A bearing assembly as in claim 1 further comprising a bearing body received radially inside of said bearing flange for centering said flange radially with respect to said piston rod.

8. A bearing assembly as in claim 7 wherein said bearing body is integrally formed with one of said slide bearings.

9. A bearing assembly as in claim 1 wherein said counter-bearing comprises an upper shell and a lower shell, which form respective upper and lower sides of said flange, and an elastomer body arranged between said shells, said elastomer body loading said sides axially toward said slide bearings.
